(19) United States
(12) Patent Application Publication
(10) Pub. No.: US 2024/0076452 A1
(43) Pub. Date: Mar. 7, 2024

(54) Polyimide Composition, Flexible Smart Window and Method of Fabricating Flexible Smart Window

(71) Applicant: SK Innovation Co., Ltd., Seoul (KR)

(72) Inventors: Hye Jin Park, Daejeon (KR); Cheol Min Yun, Daejeon (KR)

(21) Appl. No.: 18/233,482

(22) Filed: Aug. 14, 2023

(30) Foreign Application Priority Data
Aug. 16, 2022 (KR) 10-2022-0102278

(51) Int. Cl. C08G 73/10; C08L 79/08; E06B 9/24; G02F 1/1333; G02F 1/153

(52) U.S. Cl. CPC C08G 73/1082; C08L 79/08; E06B 9/24; G02F 1/133305; G02F 1/153; E06B 2009/2464; G02F 2202/022

(57) ABSTRACT

A polyimide composition includes a polyimide precursor or a polyimide that includes structural units derived from a first monomer including a diamine-based compound and structural units derived from a second monomer including a cardo group-containing dianhydride-based compound. The cardo group-containing dianhydride-based compound is included in a range from 12 mol % to 20 mol % based on a total number of moles of the second monomer.

### CROSS-REFERENCE TO RELATED APPLICATION

This application claims priority to Korean Patent Application No. 10-2022-0102278 filed Aug. 16, 2022, the disclosure of which is hereby incorporated by reference in its entirety.

### BACKGROUND OF THE INVENTION

### 1. Field of the Invention

The present disclosure relates to a polyimide composition, a flexible smart window and a method of fabricating a flexible smart window. More particularly, the present disclosure relates to a polyimide composition comprising a diamine and an anhydride, a flexible smart window prepared using the same and a method of fabricating a flexible smart window using the same.

### 2. Description of Related Art

Recently, flexible properties have been added to various electronic devices or electrochemical devices including a display device, and flexible electrical devices such as a flexible display have been developed. To provide mechanical reliability and heat resistance while providing sufficient flexibility required for the flexible electric device, a polyimide substrate is used as a flexible substrate material.

In a device fabrication, a device process using a carrier substrate is used to improve process stability when a high-temperature heat treatment process is included. For example, a polyimide substrate may be formed on a carrier substrate such as a glass substrate, and a device process of an electronic device or an electrochemical device may be performed on the polyimide substrate. Thereafter, the polyimide substrate may be separated from the carrier substrate so that a flexible electric device including the polyimide substrate may be fabricated.

A laser lift off process may be performed to separate the polyimide substrate from the carrier substrate. Damages and by-products may occur on a surface of the polyimide substrate by an energy from the laser lift-off process.

For example, when the flexible electric device is an optical device or a display device, transmittance and display quality may be deteriorated due to damages or modification of the polyimide substrate.

### SUMMARY OF THE INVENTION

According to some embodiments of the present disclosure, there is provided a polyimide composition having improved chemical mechanical and/or thermal stability.

According to some embodiments of the present disclosure, there is provided a flexible smart window prepared using the polyimide composition.

According to some embodiments of the present disclosure, there is provided a method of fabricating a flexible smart window using the polyimide composition.

In some embodiments, there is provided a polyimide composition comprising a polyimide precursor or a polyimide that comprises structural units derived from a first monomer comprising a diamine-based compound and structural units derived from a second monomer comprising a cardo group-containing dianhydride-based compound. The cardo group-containing dianhydride-based compound is comprised in a range from 12 mol % to 20 mol % based on a total number of moles of the second monomer.

In some embodiments, the second monomer may further comprise a dianhydride-based compound devoid of (or free of) a cardo group.

In some embodiments, a molar ratio of the first monomer to the second monomer may be in a range from 0.9 to 1.1.

In some embodiments, the dianhydride-based compound devoid of (or free of) a cardo group may be a dianhydride-based compound containing a single benzene ring.

In some embodiments, the first monomer may not contain a cardo group, or be free of a cardo group.

In some embodiments, the first monomer may comprise a compound represented by Chemical Formula 1 below.

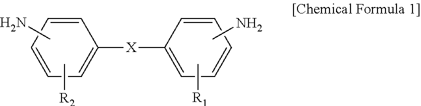

In Chemical Formula 1, R₁ and R₂ may each independently be a halogen group, a hydroxyl group (—OH), a thiol group (—SH), a nitro group (—NO₂), a cyano group, a C₁ to C₁₀ alkyl group, a C₁ to C₄ halogenoalkoxy group, a C₁ to C₁₀ halogenoalkyl group, or a C₆ to C₂₀ aryl group. X may comprise a direct bond, —O—, —CR₃R₄— or a combination thereof. R₃ and R₄ may each be independently a hydrogen atom, a C₁ to C₁₀ alkyl group or a C₁ to C₁₀ fluoroalkyl group.

In some embodiments, the cardo group-containing dianhydride-based compound may be represented by Chemical Formula 2 below.

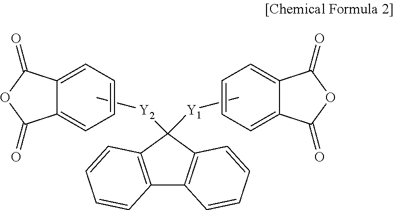

In Chemical Formula 2, Y₁ and Y₂ may each be a direct bond, —O—, or a phenylene group.

A flexible smart window comprises a first polyimide substrate and a second polyimide substrate, wherein at least one of the first polyimide substrate and/or the second polyimide substrate is formed from the polyimide composition according to the embodiments described herein, and an electrochromic device structure disposed between the first polyimide substrate and the second polyimide substrate.

In some embodiments, the electrochromic device structure may comprise a first conductive layer, an ion storage layer, an electrolyte layer, an electrochromic layer and a second conductive layer sequentially stacked from a top surface of the first polyimide substrate.

In some embodiments, each of the first polyimide substrate and the second polyimide substrate may have a coefficient of thermal expansion of 12 ppm/K or less.

In some embodiments, the first polyimide substrate and the second polyimide substrate may have the coefficient of thermal expansion in a range from −10 ppm/K to 12 ppm/K.

In a method of fabricating a flexible smart window, a first polyimide substrate and a second polyimide substrate are formed on a first carrier substrate and a second carrier substrate, respectively, wherein at least one of the first polyimide substrate and/or the second polyimide substrate is formed using a polyimide composition according to the embodiments described herein. A first conductive layer and an ion storage layer are formed sequentially on the first polyimide substrate to form a first stack structure. A second conductive layer and an electrochromic layer are sequentially formed on the second polyimide substrate to form a second stack structure. The first stack structure and the second stack structure are combined such that the ion storage layer and the electrochromic layer face each other with an electrolyte layer interposed therebetween to form a combined stack structure. The first carrier substrate and the second carrier substrate are detached from the combined stack structure by a laser lift-off process.

In some embodiments, a light energy in the laser lift-off process may be in a range from 300 mJ/cm² to 340 mJ/cm².

In some embodiments, the formation of the first stack structure and the formation of the second stack structure may comprise a heat treatment performed at a temperature of 450° C. or higher.

In some embodiments, a sacrificial layer may be formed between the first carrier substrate and the first polyimide substrate, and between the second carrier substrate and the second polyimide substrate.

The polyimide composition according to exemplary embodiments may comprise a first monomer comprising a diamine-based compound and a second monomer comprising a cardo group-containing dianhydride-based compound in a predetermined molar ratio. A protection unit for a laser lift-off (LLO) process using a light irradiation may be provided by the cardo group-containing dianhydride-based compound.

Accordingly, in a flexible smart window process in which both upper/lower LLO processes are performed, burning of polyimide substrates and generation of ash may be reduced. Additionally, thermal deformation of the polyimide substrates may be reduced, so that device deformation due to a difference in thermal expansion properties at upper and lower portions of the flexible smart window may be suppressed.

The flexible smart window process may comprise, e.g., a high-temperature heat treatment process of 450° C. or higher, and process stability may be achieved by using a polyimide substrate prepared from the polyimide composition.

### BRIEF DESCRIPTION OF THE DRAWINGS

FIG. 1 is a schematic cross-sectional view illustrating a flexible smart window in accordance with example embodiments.

FIGS. 2 to 5 are schematic cross-sectional views illustrating a method of fabricating a flexible smart window in accordance with example embodiments.

### DESCRIPTION OF THE INVENTION

According to embodiments provided in the present disclosure, a polyimide composition prepared from a diamine-based compound and a dianhydride-based compound, or a polymer thereof is provided. According to embodiments of the present disclosure, a flexible smart window comprising a polyimide substrate fabricated using the polyimide composition and a method of fabricating the flexible smart window are also provided.

Hereinafter, embodiments of the present disclosure will be described in detail with reference to examples and the accompanying drawings. However, those skilled in the art will appreciate that such embodiments and drawings are provided to further understand the spirit of the present invention and do not limit subject matters to be protected as disclosed in the detailed description and appended claims.

Furthermore, throughout the disclosure, unless otherwise particularly stated, the word “comprise”, “include”, “contain”, or “have” does not mean the exclusion of any other constituent element, but means further inclusion of other constituent elements, and elements, materials, or processes which are not further listed are not excluded.

Unless the context clearly indicates otherwise, the singular forms of the terms used in the present specification may be interpreted as including the plural forms. As used herein, the singular form of “a”, “an”, and “the” include plural referents unless the context clearly states otherwise.

The numerical range used in the present disclosure comprises all values within the range comprising the lower limit and the upper limit, increments logically derived in a form and spanning in a defined range, all double limited values, and all possible combinations of the upper limit and the lower limit in the numerical range defined in different forms. As an example, when it is defined that a content of a composition is 10% to 80% or 20% to 50%, it should be interpreted that a numerical range of 10% to 50% or 50% to 80% is also described in the specification of the present disclosure. Unless otherwise defined in the present disclosure, values which may be outside a numerical range due to experimental error or rounding off of a value are also comprised in the defined numerical range.

For the purposes of this disclosure, unless otherwise indicated, all numbers expressing quantities of ingredients, reaction conditions, dimensions, physical characteristics, and so forth used in the disclosure are to be understood as being modified in all instances by the term “about.” Hereinafter, unless otherwise particularly defined in the present disclosure, “about” may be considered as a value within 30%, 25%, 20%, 15%, 10%, 5%, 3%, 2%, 1%, 0.5%, 0.1%, 0.05% or 0.01% of a stated value. Unless indicated to the contrary, the numerical parameters set forth in this disclosure are approximations that can vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

As used herein, “formed from” or “prepared from” denotes open, e.g., “comprising,” claim language. As such, it is intended that a composition “formed from” or “prepared from” a list of recited components be a composition comprising at least these recited components or the reaction product of at least these recited components, and can further comprise other, non-recited components, during the composition's formation or preparation. As used herein, the phrase “reaction product of” means chemical reaction product(s) of the recited components, and can include partial reaction products as well as fully reacted products.

Polyimide Composition

The term “polyimide composition” as used herein refers to a composition for preparing a polyimide film or polyimide substrate. The polyimide composition may be a solution comprising a polyimide polymer, a polyimide precursor (e.g., a polyamic acid-based polymer), or monomers thereof.

In example embodiments, the polyimide composition may comprise a first monomer comprising a diamine-based compound and a second monomer comprising a dianhydride-based compound, or may comprise a polymer derived from the first monomer and the second monomer. The polymer may comprise the polyimide precursor, and the polyimide precursor may comprise structural units derived from the first monomer and structural units derived from the second monomer.

The first monomer may comprise an aromatic diamine-based compound. As used herein, the term “aromatic” is used to encompass a compound having aromaticity entirely or a compound comprising an aromatic ring such as a benzene ring in a molecular structure thereof.

For example, the first monomer may comprise a compound represented by Chemical Formula 1 below.

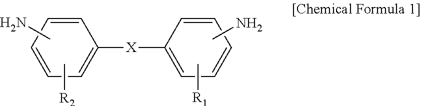

In Chemical Formula 1, X may comprise a direct bond (a single bond), —O—, —CR₃R₄—, or a combination thereof. R₃ and R₄ may each independently be a hydrogen atom, a C₁ to C₁₀ (having 1 to 10 carbon atoms) alkyl group, or a C₁ to C₁₀ fluoroalkyl group.

R₁ and R₂ may each independently be a halogen group, such as —F, —Cl, —Br or —I, a hydroxyl group (—OH), a thiol group (—SH), a nitro group (—NO₂), a cyano group, a C₁ to C₁₀ alkyl group, a C₁ to C₄ halogenoalkoxy group, a C₁ to C₁₀ halogenoalkyl group, or a C₆ to C₂₀ aryl group.

In some embodiments, R₁ and R₂ may each independently be a fluoro (—F) group or a C₁ to C₁₀ fluoroalkyl group.

In some embodiments, the first monomer may not comprise, or may be free of, an amide group, an ester group, a urea group or a urethane bond in a molecule structure thereof. Accordingly, generation of ash in a detachment process may be more effectively prevented without inhibiting an action of a cardo group of the second monomer as will be described later. Additionally, haze of the polyimide substrate may be suppressed and/or transmittance may be improved.

For example, the first monomer may comprise a compound represented by Chemical Formula 1-1 below.

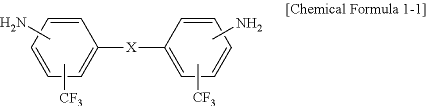

In an embodiment, in Chemical Formula 1-1, X may represent a direct bond. In this case, the first monomer may comprise a TFMB-based compound such as 4,4′-diamino-2,2′-bis(trifluoromethyl)biphenyl.

In some embodiments, the first monomer may not comprise, or may be free of, a cardo group (or fluorenyl group) in a molecule structure thereof. Accordingly, excessive increase of a coefficient of thermal expansion (CTE) or yellowing of the polyimide substrate may be prevented.

In some embodiments, the second monomer may comprise a dianhydride-based compound bonded with a cardo group, e.g., a cardo group-containing dianhydride-based compound. The term “cardo group” as used herein may refer to a pendant ring structure formed by a fluorenyl group.

For example, the second monomer may comprise a compound represented by Chemical Formula 2 below.

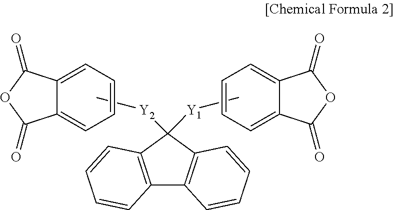

In Chemical Formula 2, Y₁ and Y₂ may each be a direct bond (a single bond), —O—, or a phenylene group.

In an embodiment, Y₁ and Y₂ may each represent a direct bond. In this case, the second monomer may comprise 9,9-bis(3,4-dicarboxyphenyl)fluorene dianhydride (BPAF).

The cardo group may be comprised in the dianhydride to improve stability and heat resistance in a laser lift-off (LLO) process as will be described later. For example, the cardo groups may be distributed in a predetermined range within a polyimide structure, and may serve as protection units that prevent ash from occurring on a peeled surface of the polyimide substrate.

Further, an excessive thermal deformation of a polyimide resin or the polyimide substrate may be prevented by the cardo group. Thus, the coefficient of thermal expansion of the polyimide substrate may be reduced, and a stable flexible device process may be implemented.

In some embodiments, the second monomer may further comprise a dianhydride-based compound that does not contain, or is free of, a cardo group (cardo group-free). For example, the second monomer may further comprise an aromatic dianhydride devoid of a cardo group.

The aromatic dianhydride devoid of a cardo group may comprise a tetracarboxylic acid dianhydride comprising a benzene ring. For example, the aromatic dianhydride devoid of a cardo group may comprise a compound represented by Chemical Formula 3 or Chemical Formula 4 below.

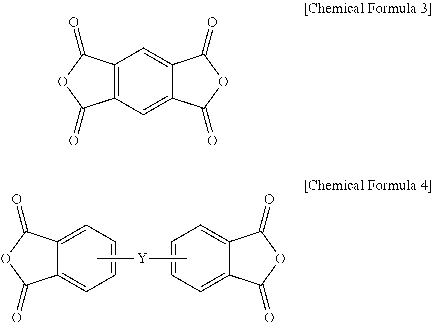

In Chemical Formula 4, Y may comprise a direct bond (a single bond), —O—, —CR₅R₆—, —(C═O)—, —(S═O)—, —(SO₂)—, or a combination thereof. R₅ and R₆ may each independently be a hydrogen atom, an C₁ to C₁₀ alkyl group, or a C₁ to C₁₀ fluoroalkyl group. For example, R₅ and R₆ may each be a C₁ to C₁₀ fluoroalkyl group.

In some embodiments, the aromatic dianhydride devoid of a cardo group may comprise a compound having a single benzene ring as shown in Chemical Formula 3. Accordingly, deterioration of flexibility of the polyimide substrate due to an excessive increase of a content of an aromatic unit may be prevented.

In some embodiments, the second monomer may not comprise, or may be free of, an amide group, an ester group, a urea group, or a urethane bond in a molecule structure thereof. Accordingly, generation of ash in the detachment process and reduction of transmittance of the polyimide substrate may be more effectively prevented without inhibiting the action of the cardo group of the above-described second monomer.

In some embodiments, the monomer or the polymer comprised in the polyimide composition may not comprise, or may be free of, a silicon-containing group (e.g., a siloxane group). Accordingly, brittleness of the polyimide substrate caused by the silicon-containing group may be prevented, and/or fractures and/or cracks of the polyimide substrate may be suppressed in the LLO process or a high-temperature device process.

In some embodiments, the cardo group-containing dianhydride-based compound may be comprised in a range of 12 mol % to 20 mol % based on a total number of moles of the second monomers.

If the content of the cardo group-containing dianhydride-based compound is less than 12 mol %, the effects of reducing ash and increasing heat resistance from the cardo group may not be sufficiently implemented. Further, the coefficient of thermal expansion (CTE) of the polyimide substrate may be excessively reduced (e.g., excessively reduced to a negative value). Accordingly, when the polyimide substrate is separated from the carrier substrate, curl, warpage or wrinkles of the polyimide substrate may be caused.

If the content of the cardo group-containing dianhydride-based compound exceeds 20 mol %, the coefficient of thermal expansion (CTE) of the polyimide substrate may be excessively increased or mechanical damages such as cracks of the polyimide substrate may be caused in the LLO process.

In some embodiments, the content of the cardo group-containing dianhydride-based compound may be in a range from 12 mol % to 18 mol %, or from 13 mol % to 18 mol %, or from 13.5 mol % to 17.5 mol %.

In some embodiments, a content of an aliphatic dianhydride based on a total number of moles of the second monomer may be 10 mol % or less. The term “aliphatic dianhydride” as used herein may refer to a dianhydride-based compound that does not contain, or is free of, an aromatic ring in a molecular structure thereof.

In some embodiments, the content of the aliphatic dianhydride may be less than 10 mol % based on the total number of moles of the second monomer. For example, the content of the aliphatic dianhydride may be 5 mol % or less, 1 mol % or less, or 0.5 mol % or less. Within the above range, generation of haze and/or reduction of transmittance of the polyimide substrate may be effectively prevented. In some embodiments, the second monomer may not comprise, or may be free of, the aliphatic dianhydride.

The polyimide composition may comprise a polyimide precursor or polyimide in the form of a polymer of the first monomer and the second monomer. The polyimide precursor may have a polyamic acid polymer structure.

In some embodiments, the polyamic acid polymer structure may not comprise, or may be free of, an amide group, an ester group, a urea group or a urethane bond in a molecule structure thereof.

The polyamic acid polymer and the polyimide polymer formed therefrom comprise a first monomer-derived unit and a second monomer-derived unit, and a molar ratio of a unit derived from the cardo group-containing dianhydride-based compound among the second monomer-derived units may be adjusted or maintained within the above-described range.

In the polyimide composition, the first monomer (or a unit derived therefrom) and the second monomer (or a unit derived therefrom) may be comprised as substantially the same equivalent amount.

For example, a molar ratio of the first monomer to the second monomer may be from 0.9 to 1.1, from 0.95 to 1.05, or from 0.98 to 1.02.

The polyimide composition may further comprise an organic solvent for dissolving the first monomer and the second monomer, or the polyimide precursor formed by a polymerization thereof. For example, the first monomer and the second monomer may be mixed in the organic solvent and solution-polymerized to be present in the composition in the form of the polyimide precursor.

For example, the organic solvent may comprise ethylene glycol monomethyl ether, ethylene glycol monoethyl ether, methyl cellosolve acetate, ethyl cellosolve acetate, diethylene glycol monomethyl ether, diethylene glycol monoethyl ether, propylene glycol methyl ether, propylene glycol methyl ether acetate, propylene glycol propyl ether acetate, 1-methoxy-2-propanol acetate, 1-methoxy-2-propanol, diethylene glycol dimethyl ether, ethyl lactate, toluene, xylene, methyl ethyl ketone, cyclohexanone, heptanone, γ-butyrolactone, N-methyl-2-pyrrolidone (NMP), m-cresol, and/or N,N-diethylacetamide, etc. These may be used alone or in a combination thereof. An amount of the organic solvent may be controlled in a range capable of sufficiently dissolving the above-described monomers and maintaining the solution-polymerization.

Flexible Smart Window and Method of Fabricating the Same

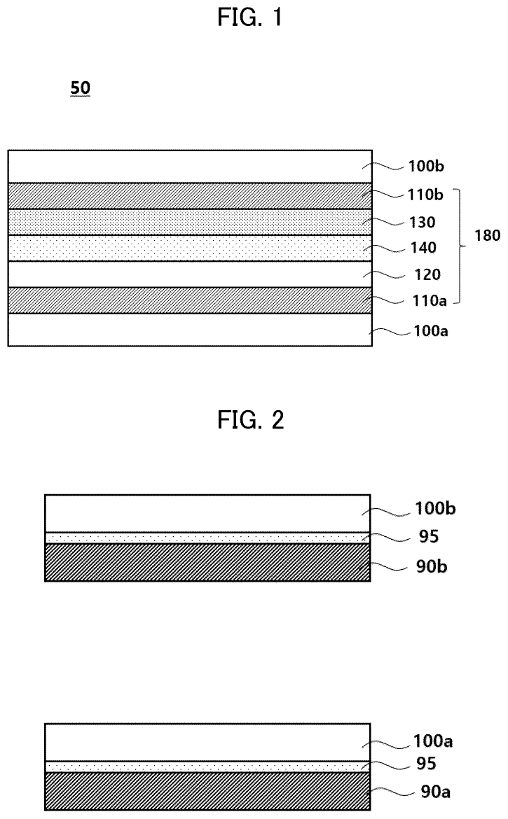

FIG. 1 is a schematic cross-sectional view illustrating a flexible smart window in accordance with example embodiments.

The term “smart window” as used herein refers to an electric device capable of realizing a display function by changing a light transmittance when a voltage is applied. In some embodiments, the smart window may comprise an electrochromic device.

Referring to FIG. 1, a flexible smart window 50 may comprise an electrochromic device structure 180 disposed between a first polyimide substrate 100a and a second polyimide substrate 100b.

The polyimide substrates 100a and 100b may be formed using the polyimide composition according to the above-described embodiments. For example, a polyimide precursor in the form of a polyamic acid polymer comprised in the polyimide composition may be converted into a polyimide polymer through an imidization reaction.

In example embodiments, a coefficient of thermal expansion (CTE) of each of the polyimide substrates 100a and 100b may be 12 ppm/K or less, e.g., less than 12 ppm/K or less.

In some embodiments, each coefficient of thermal expansion (CTE) of the polyimide substrates 100a and 100b may be in a range from −10 ppm/K to 12 ppm/K. Within the above range, cracks and/or wrinkles may be prevented during a detachment process of the polyimide substrates 100a and 100b. For example, the coefficient of thermal expansion (CTE) of each of the polyimide substrates 100a and 100b may be independently −9 ppm/K or more and less than 12 ppm/K, −7 ppm/K or more and less than 12 ppm/K, or 0 or more and less than 12 ppm/K.

In some embodiments, a yellow index (YI) of the polyimide substrates 100a and 100b may be in a range from 10 to 30, or from 10 to 25, or from 20 to 23.

In the flexible smart window according to example embodiments comprising the structure sandwiched by the polyimide substrates 100a and 100b, the coefficient of thermal expansion may be adjusted within the above-described range, so that thermal deformation in upper and lower layers of the device may be suppressed and stable flexible properties may be implemented.

Each glass transition temperature of the first and second polyimide substrates 100a and 100b may be about 450° C. or higher. Accordingly, the first and second polyimide substrates 100a and 100b may be stably applied to an electrochromic device process involving a high-temperature process of 450° C. to 500° C. Thus, the electrochromic device structure 180 manufactured by a high-temperature process may provide improved variable response speed and electrochromic performance when current/voltage is applied.

In some embodiments, each of the first and second polyimide substrates 100a and 100b may have a thickness from 1 μm to 50 μm, or from 3 μm to 20 μm, or from 5 μm to 10 μm. Within the above thickness range, the electrochromic device structure 180 may be sufficiently protected from external impact and/or contamination while providing improved transparency and/or flexibility.

The electrochromic device structure 180 may comprise a first conductive layer 110a, an ion storage layer 120, an electrolyte layer 140, an electrochromic layer 130 and a second conductive layer 110b sequentially stacked from a top surface of the first polyimide substrate 100a.

Each of the first conductive layer 110a and the second conductive layer 110b may comprise a transparent conductive oxide. The transparent conductive oxide may comprise, e.g., ITO (Indium Tin Oxide), TTO (Tantalum doped Tin Oxide), In₂O₃ (Indium Oxide), IGO (Indium Gallium Oxide), FTO (Fluor doped Tin Oxide), AZO (Aluminium doped Zinc Oxide), GZO (Galium doped Zinc Oxide), ATO (Antimony doped Tin Oxide), IZO (Indium doped Zinc Oxide), NTO (Niobium doped Titanium Oxide), ZnO (Zink Oxide), CTO (Cesium Tungsten Oxide), etc. These may be used alone or in a combination thereof.

In some embodiments, in consideration of transparency and a response speed of the electrochromic device structure 180, the first conductive layer 110a and the second conductive layer 110b may comprise ITO and/or TTO.

Each of the first conductive layer 110a and the second conductive layer 110b may have a thickness from 20 nm to 400 nm, or from 50 nm to 350 nm, or from 100 nm to 300 nm. Within the above thickness range, the flexible smart window having improved conductivity and transmittance may be easily implemented while suppressing an excessive thickness increase.

The ion storage layer 120 may be comprised as a layer for storing and transporting electrolyte ions used in an electrochromic reaction. For example, the ion storage layer 120 may comprise an oxide or a hydroxide of at least one of Ni, Co, and/or Mn.

For example, the ion storage layer 120 may have a thickness from 50 nm to 500 nm. In an embodiment, the thickness of the ion storage layer 120 may be in a range from 80 nm to 450 nm, or from 100 nm to 250 nm. Within the above thickness range, a charge balance with the electrochromic layer 130 may be maintained while containing a sufficient amount of electrolyte ions.

The electrochromic layer 130 may comprise a material having variable transmittance or color when a current is supplied, and may be provided as a substantial electrochromic device layer.

For example, the electrochromic layer 130 may comprise at least one of a reductive electrochromic material and/or an oxidative electrochromic material. For example, the reductive electrochromic material may comprise at least one oxide selected from Ti, Nb, Mo, Ta, and/or W, etc. The oxidative electrochromic material may comprise at least one oxide or hydroxide selected from Cr, Mn, Fe, Co, Ni, Rh, Jr, etc., and/or Prussian blue.

For example, the electrochromic layer 130 may have a thickness from 20 nm to 400 nm. In some embodiments, the thickness of the electrochromic layer 130 may be in a range from 30 nm to 350 nm, or from 50 nm to 100 nm. Within the above thickness range, a sufficient amount of an electrochromic material and improved resolution may be provided while implementing a thin device.

The electrolyte layer 140 may transfer electrolyte ions involved in the electrochromic reaction to the electrochromic layer 130. For example, the electrolyte ions may be transferred from the ion storage layer 120 to the electrochromic layer 130 through the electrolyte layer 140.

For example, the electrolyte layer 140 may comprise at least one of a liquid electrolyte, a gel polymer electrolyte or an inorganic solid electrolyte.

In an embodiment, the electrolyte layer 140 may comprise a metal salt and a solvent. The metal salt may comprise, e.g., H⁺, Li⁺, Na⁺, K⁺, Rb⁺, Cs⁺, etc. These may be comprised alone or in a combination thereof. For example, the electrolyte layer 140 may comprise a lithium salt compound such as LiClO₄, LiBF₄, LiAsF₆, or LiPF₆, or a sodium salt compound such as NaClO₄.

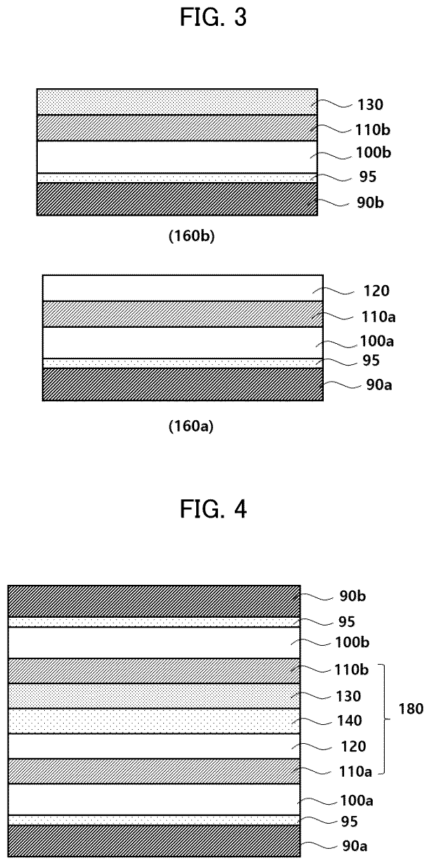

FIGS. 2 to 5 are schematic cross-sectional views illustrating a method of fabricating a flexible smart window in accordance with example embodiments.

Referring to FIG. 2, a first polyimide substrate 100a and a second polyimide substrate 100b may be formed on a first carrier substrate 90a and a second carrier substrate 90b, respectively.

In some embodiments, a preliminary polyimide layer may be formed by coating the polyimide composition according to the embodiments described herein on the first carrier substrate 90a and the second carrier substrate 90b. Thereafter, the preliminary polyimide layer may be thermally cured to form the first polyimide substrate 100a and the second polyimide substrate 100b.

In some embodiments, the thermal curing process may comprise a high temperature heat treatment of 450° C. or higher. The second monomer or the polyimide precursor comprising the cardo group in the above range may be used, so that yellowing may be prevented even in the high-temperature heat treatment, and the polyimide substrate having high transmittance, high heat resistance and/or high glass transition temperature may be formed.

In some embodiments, the thermal curing process may comprise a high temperature heat treatment performed at a temperature ranging from 450° C. to 550° C., or from 450° C. to 500° C.

In some embodiments, the thermal curing process may comprise a first heat treatment performed at a temperature ranging from 50° C. to 100° C. and a second heat treatment performed at a temperature of 450° C. or more. The first heat treatment and the second heat treatment may be sequentially performed.

The first heat treatment performed at a relatively low temperature may be performed in advance, positions of the cardo groups comprised in the polymer may be stably maintained and uniformly distributed. Additionally, deterioration of thermal properties due to a rapid high-temperature dehydration and condensation may be prevented.

In some embodiments, a sacrificial layer 95 may be formed between the first carrier substrate 90a and the first polyimide substrate 100a, and may be formed between the second carrier substrate 90b and the second polyimide substrate 100b. The sacrificial layer 95 may promote a separation of the polyimide substrates 100a and 100b in the laser lift-off (LLO) process which will be described later.

For example, the sacrificial layer 95 may be formed by depositing an inorganic material such as silicon nitride (SiNx), amorphous silicon (a-Si) or gallium nitride (GaN) on the carrier substrates 90a and 90b. In some embodiments, the sacrificial layer 95 may be omitted.

Referring to FIG. 3, a first stack structure 160a and a second stack structure 160b comprising the first polyimide substrate 100a and the second polyimide substrate 100b, respectively, may be formed.

The above-described transparent conductive oxide may be deposited on the first polyimide substrate 100a to form the first conductive layer 110a. The ion storage layer 120 may be formed on the first conductive layer 110a to obtain the first stack structure 160a. The first stack structure 160a may serve as a cathode stack.

For example, a coating composition comprising one or more oxides or hydroxides selected from Ni, Co and/or Mn, a solvent and a silane-based compound may be coated on the first conductive layer 110a, and fired at a temperature of 450° C. or higher to form the ion storage layer 120.

For example, the solvent such as alcohol may be removed at a temperature of 450° C. or higher, and the solid ion storage layer 120 may be formed through a condensation and a hydrolysis of the silane-based compound. In an embodiment, the firing temperature for forming the ion storage layer 120 may be in a range from 450° C. to 500° C.

The above-described transparent conductive oxide may be deposited on the second polyimide substrate 100b to form the second conductive layer 110b. The electrochromic layer 130 may be formed on the second conductive layer 110b to obtain the second stack structure 160b. The second stack structure 160b may serve as an anode stack.

For example, a coating composition comprising the above-described electrochromic material, a solvent and a silane-based compound may be coated on the second conductive layer 110b, and fired at a temperature of 450° C. or higher to form the electrochromic layer 130.

For example, the solvent such as alcohol may be removed at a temperature of 450° C. or higher, and the solid electrochromic layer 130 may be formed through a condensation and a hydrolysis of the silane-based compound. In an embodiment, a firing temperature for forming the electrochromic layer 130 may be in a range from 450° C. to 500° C.

In some embodiments, a firing temperature for forming the electrochromic layer 130 and a firing temperature for forming the ion storage layer 120 may be different from each other. For example, the firing temperature for forming the electrochromic layer 130 may be higher than the firing temperature for forming the ion storage layer 120. In this case, reliability and durability of the electrochromic device structure 180 may be further improved.

As described above, in the electrochromic device process of the flexible smart window, the high-temperature firing or the high-temperature heat treatment process of 450° C. or higher may be included. Accordingly, stability of the electrochromic device structure 180 in a high-temperature driving or repeated electrochromic driving may be improved.

In some embodiments, the polyimide substrates 100a and 100b formed from the polyimide composition as described above may serve as a support for the electrochromic device process.

Thus, high-temperature stability that may not be achieved in a glass material or a resin substrate such as PET may be provided, and a sufficient glass transition temperature may be provided. Accordingly, deterioration of flexibility and transmittance due to damages to the substrate in the electrochromic device process may be prevented.

Referring to FIG. 4, the first stack structure 160a and the second stack structure 160b may be coupled with the electrolyte layer 140 therebetween to form the electronic device structure 180 disposed between the first and second polyimide substrates 100a and 100b.

In some embodiments, the first stack structure 160a and the second stack structure 160b may be laminated to each other so that the electrochromic layer 130 and the ion storage layer 120 may be in contact with the electrolyte layer 140.

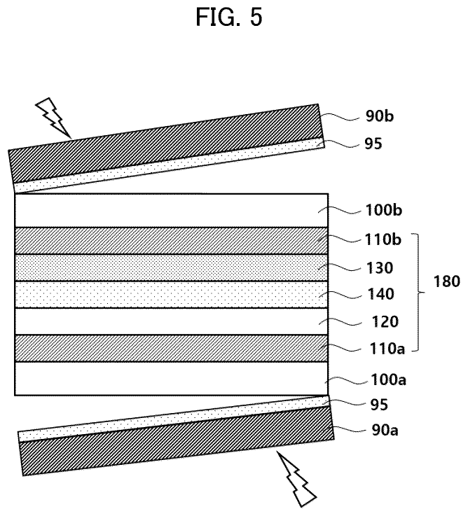

Referring to FIG. 5, the first carrier substrate 90a and the second carrier substrate 90b may be detached or separated from the first polyimide substrate 100a and the second polyimide substrate 100b, respectively, through the laser lift-off (LLO) process.

In some embodiments, the sacrificial layer 95 may also be removed or peeled-off together with the carrier substrates 90a and 90b.

For example, a laser light may be irradiated to the sacrificial layer 95 through the first carrier substrate 90a to separate the first carrier substrate 90a and the sacrificial layer 95 from the first polyimide substrate 100a.

For example, a laser light may be irradiated to the sacrificial layer 95 through the second carrier substrate 90b to separate the second carrier substrate 90b and the sacrificial layer 95 from the second polyimide substrate 100b.

The laser light may be transmitted through the carrier substrates 90a and 90b and may be absorbed by the sacrificial layer 95. For example, the sacrificial layer 95 may be carbonized by the laser light, so that adhesion to the polyimide substrates 100a and 100b may be lowered. Accordingly, detachment of the carrier substrates 90a and 90b may be promoted by the sacrificial layer 95.

In some embodiments, the sacrificial layer 95 may be omitted, and the carrier substrates 90a and 90b may be directly separated from the polyimide substrates 100a and 100b after irradiation of the laser light.

In some embodiments, the laser light may be a light in a wavelength range from 190 nm to 345 nm, or from 250 nm to 340 nm, or from 290 nm to 310 nm.

In some embodiments, a light energy from 300 mJ/cm² to 340 mJ/cm² may be applied through the LLO process. Within the above range, the carbonization of the sacrificial layer 95 may be sufficiently induced while suppressing deformation and ash of the polyimide substrates 100a and 100b.

As described above, the polyimide substrates 100a and 100b may comprise a polyimide resin comprising cardo groups within a predetermined content range. The cardo group may be distributed in a resin backbone as a protective unit of the polyimide resin. Accordingly, generation of ash resulting from the polyimide substrates 100a and 100b in the LLO process may be suppressed or reduced.

For example, cracks caused by a stress applied to the carrier substrates 90a and 90b during the detachment process may be suppressed or reduced by the cardo unit.

In some embodiments, a protective film may be attached to each of the detachment surfaces of the polyimide substrates 100a and 100b.

Hereinafter, preferred examples are proposed to more concretely describe the present inventive concepts. However, the following examples are only given for illustrating the present inventive concepts and those skilled in the related art will obviously understand that various alterations and modifications are possible within the scope and spirit of the present invention. Such alterations and modifications are duly included in the appended claims.

### Example 1

### Preparation of Polyimide Composition

A first monomer (TFMB) and a second monomer (cardo group-containing dianhydride: BPAF, dianhydride devoid of cardo group: PMDA) were mixed in dimethylacetamide (DMAc) as an organic solvent in a molar ratio shown in Table 1 in a reactor. A polyimide composition was prepared by dissolving and stirring for a certain period of time while maintaining a temperature of the reactor at 25° C. A solid content of the prepared polyimide composition was adjusted in a range of 8 wt % to 13 wt %, and a viscosity was adjusted in a range of 2,500 cp to 5,000 cp.

### Fabrication of Polyimide Substrate

Carrier substrates formed of non-alkali glass and having a thickness of 0.7 mm were prepared.

The polyimide composition as described above was coated on the carrier substrate, and

a temperature was increased at a ramping rate of 5° C./min under an oxygen concentration of 100 LPM or less to perform a first heat treatment at 80° C. for 30 minutes and a second heat treatment at 480° C. for 25 minutes to form a polyimide substrate (thickness: 4 μm).

### Other Examples and Comparative Examples

Polyimide substrate samples were prepared by the same method as that in Example 1, except that types and contents (molar ratio) of the monomers contained in the polyimide composition were changed as shown in Tables 1 and 2 below. In Table 2, the term “Comparative Example” is abbreviated as “Com Ex.”

TABLE 1

| | | Example | Example | Example | Example |
|---|---|---|---|---|---|
| monomer | | 1 | 2 | 3 | 4 |
| first monomer | TFMB | 0.99 | 1.01 | 0.99 | 1.01 |
| second | BPAF | 0.175 | 0.135 | 0.12 | 0.12 |
| monomer | | | | | |
| (containing | | | | | |
| cardo group) | | | | | |
| second | PMDA | 0.825 | 0.865 | 0.88 | 0.88 |
| monomer | | | | | |
| (cardo | 6FDA | — | — | — | — |
| group-free) | | | | | |

TABLE 2

| | | Com | Com | Com | Com | Com | Com | Com |
|---|---|---|---|---|---|---|---|---|
| monomer | | Ex 1 | Ex 2 | Ex 3 | Ex 4 | Ex 5 | Ex 6 | Ex 7 |
| first | TFMB | 0.99 | 0.99 | 0.99 | 0.99 | 1.0 | 0.8 | 1.0 |
| monomer | BAF | — | — | — | — | — | 0.2 | — |
| second | BPAF | 0.3 | 0.6 | 1.0 | — | | — | — |
| monomer | | | | | | | | |
| (containing | | | | | | | | |
| cardo group) | | | | | | | | |
| second | PMDA | 0.7 | 0.4 | — | 0.825 | — | 1.0 | 1.0 |
| monomer | 6FDA | — | — | — | 0.175 | 0.15 | — | — |
| (cardo | TPC | — | — | — | — | 0.7 | — | — |
| group-free) | CBDA | — | — | — | — | 0.15 | — | — |

The compounds listed in Tables 1 and 2 are as follows:
i) TFMB: 2,2′-bis(trifluoromethyl)benzidine
ii) BPAF: 9,9-bis(3,4-dicarboxyphenyl)fluorene dianhydride
iii) PMDA: pyromellitic dianhydride
iv) 6FDA: 4,4′-(hexafluoroisopropylidene)diphthalic anhydride
v) TPC: p-terephthaloyl chloride
vi) CBDA: 1,2,3,4-cyclobutanetetracarboxylic dianhydride
vii) BAF: a compound of Chemical Formula 5 below

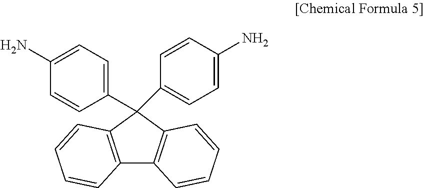 [SMILES: Nc1ccc(C2(c3ccc(N)cc3)c3ccccc3-c3ccccc32)cc1]

### EXPERIMENTAL EXAMPLE

### (1) Measurement of Detachable Light Energy

A laser light of 308 nm was irradiated toward the carrier substrate included in the polyimide substrate sample prepared according to each of Examples and Comparative Examples. During the light irradiation, a minimum light energy at which the carrier substrate was able to be completely separated from the polyimide substrate was measured.

### (2) Evaluation on Crack Generation

As described above, after performing the LLO process at the minimum light energy, cracks on a surface of the polyimide substrate were visually observed. The case where cracks were not observed was evaluated as “O”, and the case where cracks were observed was evaluated as “X.”

### (3) Evaluation on Ash Generation

A light irradiation was performed with a total light energy of 340 mJ/cm² using 308 nm laser light toward the carrier substrate included in the polyimide substrate samples prepared according to Examples and Comparative Examples, and then the carrier substrate was separated from the polyimide substrate.

After the LLO process, generation of ashes on the surface of the polyimide substrate was visually observed. The case where the ashes were not observed was evaluated as “0”, and the case where the ashes were observed was evaluated as “X.”

### (4) Evaluation on Yellowing

The polyimide compositions of Examples and Comparative Examples were cured under conditions of 4 μm thickness and 480° C., and yellow index (YI) was evaluated using a Color Quest (Hunter Lab Co.) device (ASTM D1925).

In Comparative Example 5, a high-temperature curing was not able to be performed, and the evaluation was conducted after curing at 300° C.

### (5) Evaluation on Coefficient of Thermal Expansion

Coefficients of thermal expansion of the polyimide films of the above-described Examples and Comparative Examples were measured using a thermomechanical analyzer (TMA 450, TA Instruments Co.).

Specifically, a polyimide film sample having a size of 5 mm×20 mm (length: 16 mm) was prepared and loaded into the thermomechanical analyzer. While setting a pulling force of the sample to 0.02 N, a first heating process proceeded at a rate of 4° C./min in a range from 100° C. to 450° C., and then a first cooling was conducted at a rate of 5° C./min in a range from 450° C. to 50° C.

Thereafter, a second heating process was performed at a ramping rate of 4° C./min in a range from 50° C. to 490° C., and the coefficient of thermal expansion (CTE) of the polyimide film was measured within a specific temperature range (If Tg was present, the CTE was measured in a range of 100° C. to Tg. If Tg was not present, the CTE was measured in a range of 100° C. to 480° C.)

The results are shown in Tables 3 and 4 below.

TABLE 3

| | Example 1 | Example 2 | Example 3 | Example 4 |
|---|---|---|---|---|
| detachable minimum | 320 | 300 | 300 | 300 |
| light energy | | | | |
| (mJ/cm²) | | | | |
| crack generation | ◯ | ◯ | ◯ | ◯ |
| ash generation | ◯ | ◯ | ◯ | ◯ |
| yellow index (YI) | 20 | 21 | 22 | 21 |
| CTE (ppm/K) | 11 | 2 | −7 | −9 |

TABLE 4

| | Com | Com | Com | Com | Com | Com | Com |
|---|---|---|---|---|---|---|---|
| | Ex 1 | Ex 2 | Ex 3 | Ex 4 | Ex 5 | Ex 6 | Ex 7 |
| detachable minimum | 330 | 310 | 310 | 320 | 200 | 340 | 280 |
| light energy | | | | | | | |
| (m.J/cm²) | | | | | | | |
| crack generation | X | X | X | ◯ | ◯ | X | ◯ |
| ash generation | ◯ | ◯ | ◯ | X | X | X | X |
| yellow index (YI) | 19 | 16 | 15 | 35 | 2 | 43 | 26 |
| CTE (ppm/K) | 81 | 87 | 84 | 8.5 | 12 | 60 | −5 |

Referring to Tables 3 and 4, in Examples where the cardo group-containing dianhydride monomer was included within the above-described molar ratio, improved transmittance and thermal stability were obtained while preventing ash/cracks after the LLO process. Additionally, the LLO process was implemented using a relatively low energy compared to that in Comparative Examples.

In Comparative Examples 1 to 3 where the amount of the cardo group-containing dianhydride monomer was excessively increased, the CTE was excessively increased and cracks were generated after the LLO process.

In Comparative Examples 4 to 7 where the cardo group-containing dianhydride monomer was not included in the second monomer, ash was observed in an entire area from the polyimide substrate after the LLO process. In Comparative Example 7, the CTE decreased to a negative value.

In Comparative Example 5, the cardo group-containing dianhydride monomer was not included in the second monomer and an aliphatic amide bond was included in the polyimide precursor (polyamic acid resin), and a haze phenomenon was observed on the polyimide substrate and transmittance was reduced.

In Comparative Example 6 where the cardo group was included in the first monomer (diamine compound), the detachable minimum light energy and the CTE were increased, and yellowing of the polyimide substrate was increased.

What is claimed is:

1. A polyimide composition comprising a polyimide precursor or a polyimide that comprises structural units derived from a first monomer comprising a diamine-based compound and structural units derived from a second monomer comprising a cardo group-containing dianhydride-based compound,
wherein the cardo group-containing dianhydride-based compound is comprised in a range from 12 mol % to 20 mol % based on a total number of moles of the second monomer.

2. The polyimide composition according to claim 1, wherein the second monomer further comprises a dianhydride-based compound devoid of a cardo group.

3. The polyimide composition according to claim 2, wherein a molar ratio of the first monomer to the second monomer is in a range from 0.9 to 1.1.

4. The polyimide composition according to claim 2, wherein the dianhydride-based compound free of a cardo group is a dianhydride-based compound containing a single benzene ring.

5. The polyimide composition according to claim 1, wherein the first monomer is free of a cardo group.

6. The polyimide composition according to claim 1, wherein the first monomer comprises a compound represented by Chemical Formula 1: 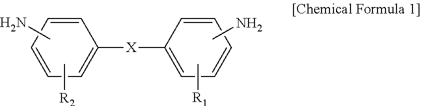
wherein, in Chemical Formula 1, R₁ and R₂ are each independently a halogen group, a hydroxyl group (—OH), a thiol group (—SH), a nitro group (—NO₂), a cyano group, a C₁ to C₁₀ alkyl group, a C₁ to C₄ halogenoalkoxy group, a C₁ to C₁₀ halogenoalkyl group, or a C₆ to C₂₀ aryl group,
X comprises a direct bond, —O—, —CR₃R₄— or a combination thereof, and
R₃ and R₄ are each independently a hydrogen atom, a C₁ to C₁₀ alkyl group or a C₁ to C₁₀ fluoroalkyl group.

7. The polyimide composition according to claim 1, wherein the cardo group-containing dianhydride-based compound is represented by Chemical Formula 2 below: 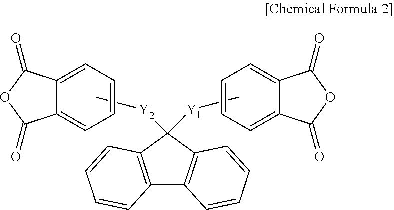
wherein, in Chemical Formula 2, Y₁ and Y₂ are each a direct bond, —O—, or a phenylene group.

8. A flexible smart window, comprising:
a first polyimide substrate and a second polyimide substrate formed from the polyimide composition of claim 1; and
an electrochromic device structure disposed between the first polyimide substrate and the second polyimide substrate.

9. The flexible smart window according to claim 8, wherein the electrochromic device structure comprises a first conductive layer, an ion storage layer, an electrolyte layer, an electrochromic layer and a second conductive layer sequentially stacked from a top surface of the first polyimide substrate.

10. The flexible smart window according to claim 8, wherein each of the first polyimide substrate and the second polyimide substrate has a coefficient of thermal expansion of 12 ppm/K or less.

11. The flexible smart window according to claim 10, wherein each of the first polyimide substrate and the second polyimide substrate has the coefficient of thermal expansion in a range from −10 ppm/K to 12 ppm/K.

12. A method of fabricating a flexible smart window, comprising:
forming a first polyimide substrate and a second polyimide substrate on a first carrier substrate and a second carrier substrate, respectively, using the polyimide composition of claim 1;
sequentially forming a first conductive layer and an ion storage layer on the first polyimide substrate to form a first stack structure;
sequentially forming a second conductive layer and an electrochromic layer on the second polyimide substrate to form a second stack structure;
combining the first stack structure and the second stack structure such that the ion storage layer and the electrochromic layer face each other with an electrolyte layer interposed therebetween to form a combined stack structure; and
detaching the first carrier substrate and the second carrier substrate from the combined stack structure by a laser lift-off process.

13. The method according to claim 12, wherein a light energy in the laser lift-off process is in a range from 300 mJ/cm² to 340 mJ/cm².

14. The method according to claim 12, wherein the formation of the first stack structure and the formation of the second stack structure comprise a heat treatment performed at a temperature of 450° C. or higher.

15. The method according to claim 12, further comprising forming a sacrificial layer between the first carrier substrate and the first polyimide substrate, and forming a sacrificial layer between the second carrier substrate and the second polyimide substrate.
